(19) United States
(12) Patent Application Publication
(10) Pub. No.: US 2013/0200122 A1
(43) Pub. Date: Aug. 8, 2013

(54) CARGO RACK FOR A UTILITY TERRAIN VEHICLE

(71) Applicant: Gerald Elson, New Plymouth, ID (US)

(72) Inventor: Gerald Elson, New Plymouth, ID (US)

(21) Appl. No.: 13/365,182

(22) Filed: Feb. 2, 2012

(51) Int. Cl. B60R 9/00

(52) U.S. Cl. 224/401

(57) ABSTRACT

This is directed to systems, processes, machines, and other means that mount a cargo rack to a Utility Terrain Vehicle (UTV). The invention can improve the UTV experience by allowing a user to easily bring a table, spare tire and a plethora of equipment on one's trip.

### CROSS REFERENCE TO RELATED APPLICATIONS

Not Applicable

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION BY REFERNCE OF MATERIAL SUBMITTED ON A COMPACT DISC

Not Applicable

### FIELD OF THE INVENTION

This invention relates to a cargo rack for a utility terrain vehicle (UTV).

### BACKGROUND OF THE INVENTION

The UTV has existed for several years, but presently lacks a meaningful way to store a plethora of equipment and other devices. The current invention solves that problem.

### BRIEF SUMMARY OF THE INVENTION

Methods, systems, and other means are provided for a UTV cargo rack. In accordance with some embodiments the UTV cargo rack comprises a basic carrier frame, a large side rack assembly, a tail-gate frame assembly, a hang-on table assembly and a small side rack assembly. To avoid the problem of excessive vibration, the invention utilizes a series of hollow tubes and hollow u-shaped tubes. Where necessary the device can be mechanically coupled to a UTV by utilizing bolts, novel screw clamps, welding the device directly to the UTV frame or some combination of these.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1: is a perspective view of the invention shown in use and omitting accessories for illustrative clarity.

FIG. 2: is a perspective view of the invention illustrated with all accessories.

FIG. 3: is a perspective view of the basic carrier frame and intentionally omitting subcomponent the basic carrier frame assembly diamond grate for illustrative clarity.

FIG. 4: is a perspective view of the large side rack frame assembly only.

FIG. 5: is a perspective view of the tail-gate frame assembly only.

FIG. 6: is a perspective view of the hang-on table frame assembly only.

FIG. 7: is a perspective view of the small side rack frame assembly.

FIG. 8: is a perspective detail view of the screw clamp shown in use.

### DETAILED DESCRIPTION OF THE INVENTION

Embodiments of the present invention overcome many of the obstacles associated with transporting materials on a utility terrain vehicle (UTV), and now will be described more fully hereinafter with reference to the accompanying drawings that show some, but not all embodiments of the claimed inventions. Indeed, the invention may be embodied in many different forms and should not be construed as limited to the embodiments set forth herein. Rather, these embodiments are provided so that this disclosure will satisfy applicable legal requirements. Like numbers refer to like elements throughout.

As used here, “pole” indicates a hollow tube. Hollow tubes strength and vibration tolerance properties that are necessary for the present invention to avoid mechanical failure. A U-pole is a hollow pole bend using conventional technology and connections between poles and plates are welded unless explained otherwise.

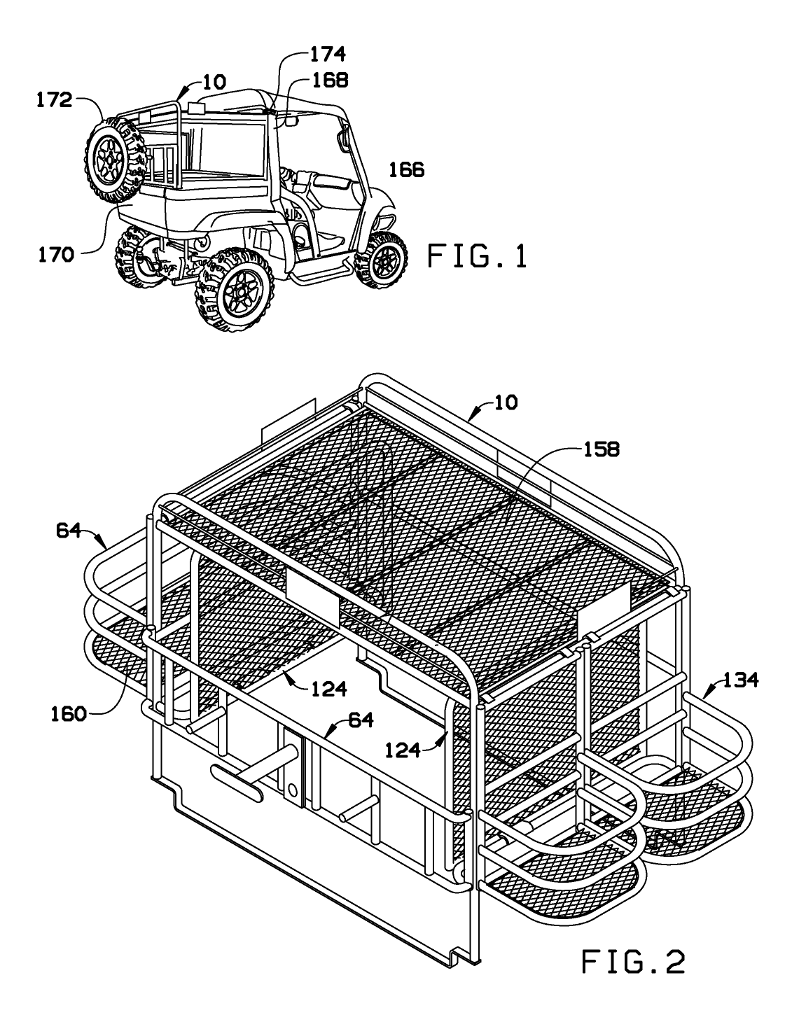

FIG. 1 shows the general layout of the invention. Utility Terrain Vehicle 166 comprises UTV frame 168 which further comprises UTV bed 170. UTV bed 170 is mechanically coupled to cargo rack 10 which comprises a plurality of hollow tubes and a plurality of hollow U-shaped tubes welded together as explained below. Cargo rack 10 is mechanically coupled to spare wheel 172 by a plurality of bolts (shown in FIG. 3) and a plurality of screw clamps (shown in FIG. 8)

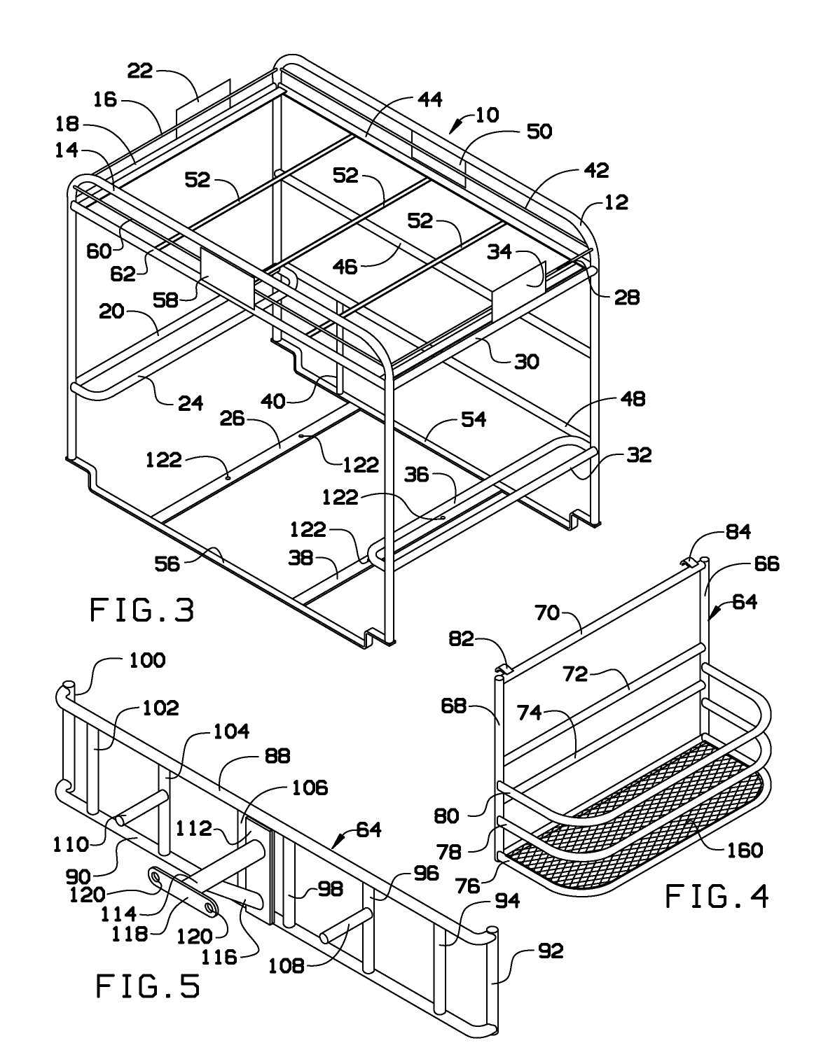

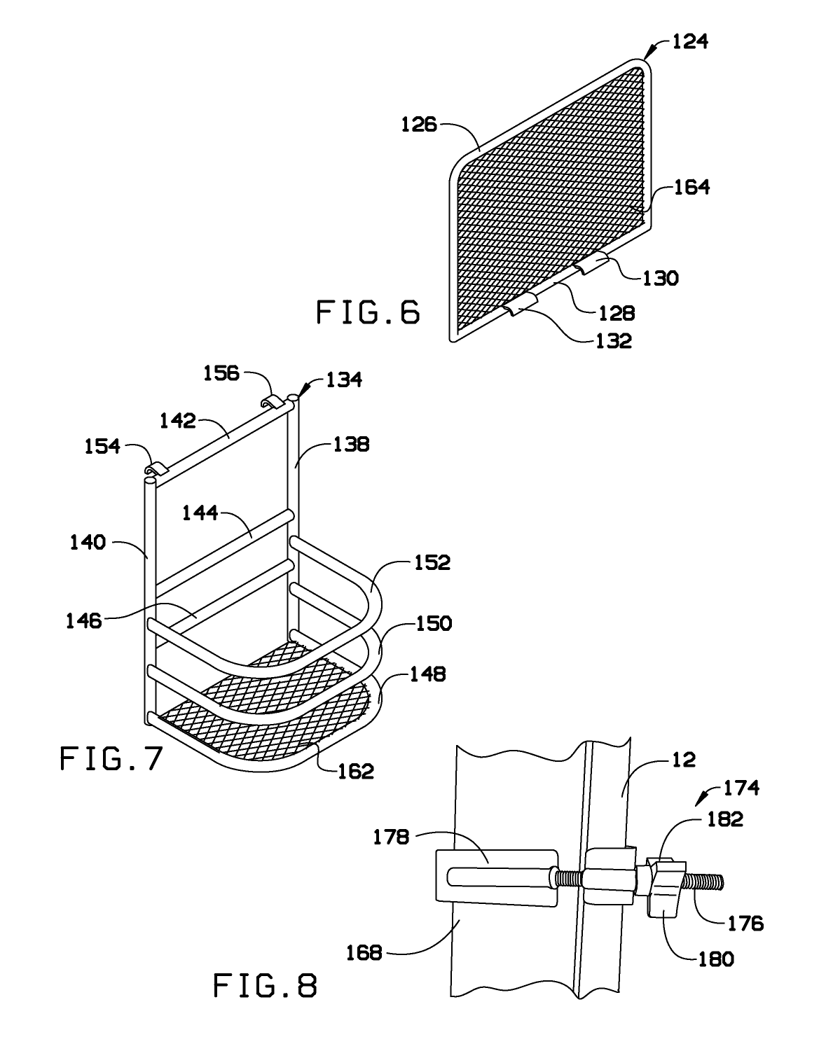

FIG. 2 shows the accessories that can be mechanically coupled to cargo rack 10. Here, cargo rack 10 comprises large side rack assembly 64 (shown in FIG. 4), tail-gate frame assembly 86 (shown in FIG. 5), small side rack frame assembly 134 (shown in FIG. 7), table frame assembly 124 (shown in FIG. 6), basic carrier frame assembly diamond gate 158 and large rack frame assembly diamond gate 160.

FIG. 3 shows cargo rack 10. Rear lower cross bar 56 is mechanically coupled to right side lower bolt bar 26, left side lower bolt bar 38, and rear U-pole bracket 14. Right side lower bolt bar 26 and left side lower bolt bar 38 are both further mechanically coupled to forward lower cross bar 54. Both right side lower bolt bar 26 and left side lower bolt bar 38 contain a plurality of bolt bar bolt holes 122. Cargo rack 10 is mechanically coupled to UTV 166 (not shown), in part, by inserting bolts through bolt bar bolt holes 122 into UTV bed 170 (not shown).

Rear U-pole bracket 14 receives lateral support and is mechanically coupled to rear sign plate pole 60 and rear cross brace pole 62. Rear sign plate 58 is mechanically coupled to rear sign plate pole 60. Forward lower cross bar 54 is further mechanically coupled to forward U-pole bracket 12. Forward U-pole bracket 12 is supported by having its left side and right side mechanically coupled by forward plate pole 42, forward upper cross brace pole 44, forward middle cross brace pole 46 and forward lower cross brace pole 48. Forward side sign plate 50 is mechanically coupled to forward plate pole 42.

Forward U-pole bracket 12 is mechanically coupled to right side plate pole 16, right side upper cross brace pole 18, right side lower cross brace pole 20, right side sign plate 22, right side inner support U-pole bracket 24, right side lower bolt bar 26, left side plate pole 28, left side upper cross brace pole 30, left side lower cross brace pole 32, left side sign plate 34 and left side inner support U-pole bracket 36. Similarly, right side plate pole 16 right side upper cross brace pole 18 right side lower cross brace pole 20, right side sign plate 22, right side inner support U-pole bracket 24, right side lower bolt bar 26, left side plate pole 28, left side upper cross brace pole 30, left side lower cross brace pole 32, left side sign plate 34 and left side inner support U-pole bracket 36 are mechanically coupled to rear U-pole bracket 14. Right side sign plate 22 is mechanically coupled to right side plate pole 16 and left side sign plate is mechanically coupled to left side plate pole 28. Additional horizontal support is provided by a plurality of v-bar grid supports 52 which are mechanically coupled to forward upper cross brace pole 33 and rear cross brace pole 62.

FIG. 4 shows large side rack assembly 64. Large side rack assembly 64 comprises upper cross brace pole 70 which is mechanically coupled to right side vertical support pole 66, left side vertical support pole 68, left hook 82 and right hook 84. Right side vertical support pole 66 is mechanically coupled to left side vertical support pole 68 by middle cross brace pole 72, lower cross brace pole 74, lower U-pole bracket 76, middle U-pole bracket 78 and upper U-pole bracket 80. Large rack frame assembly diamond grate 160 is mechanically coupled to lower U-pole bracket 76. Large side rack assembly 64 is mechanically coupled to cargo rack 10 by placing left hook 82 and right hook 84 over right side upper cross brace pole 18 (not pictured) as shown in FIG. 2.

FIG. 5 shows tail-gate frame assembly 86. Tail-gate frame assembly 86 comprises upper brace pole 88 which is mechanically coupled to lower brace pole 90 by right vertical brace pole 92, right secondary vertical brace pole 94, right tertiary vertical brace pole 96, right quaternary vertical brace pole 98, left vertical brace pole 100, left secondary vertical brace pole 102, left tertiary vertical brace pole 104 and left quaternary vertical brace pole 106 and tire bracket plate 112. Tail-gate frame assembly 86 is mechanically coupled to rear U-pole bracket 14 (not shown) by welding left vertical brace pole 100 and right vertical brace pole 92 to rear U-pole bracket 14 as shown in FIG. 2.

Tail-gate frame assembly 86 also has the capacity for holding a spare wheel. Right side tire spacer bar 108 is mechanically coupled to right tertiary vertical brace pole 96. Similarly, left side tire spacer bar 110 is mechanically coupled to left tertiary vertical brace pole 104. Tire bracket plate 112 is mechanically coupled to tire bar bracket 18 by tire bracket main pole support 114 and tire bracket angled pole support 116. Tire bracket plate 112 comprises two tire rim bolt holes 120 to which a standard sized UTV tire can be mounted using technology well known in the art.

FIG. 6 shows hang-on table frame assembly 124. Hang-on table frame assembly 124 comprises hang-on table U-pole 126 which is mechanically coupled to hang-on table cross pole brace 128. Hang-on table cross pole brace 128 is mechanically coupled to hang-on table right hook 130 and hang-on table left hook 132. Hang-on table assembly diamond grate 164 is mechanically coupled to hang-on table U-pole 126 and hang-on table cross pole brace 128.

A first hang-on table frame assembly 124 is mechanically coupled to cargo rack 10 by placing hang-on table right hook 130 and hang-on table left hook 132 on right side inner support U-pole bracket 24 as shown in FIG. 2 and FIG. 3. A second hang-on table frame assembly 124 is mechanically coupled to cargo rack 10 by placing hang-on table right hook 130 and hang-on table left hook 132 on left side inner support U-pole bracket 36 as shown in FIG. 2 and FIG. 3.

FIG. 7 shows small side rack frame assembly 134. Small side rack frame assembly 134 comprises small side rack right side vertical support pole 138 which is mechanically coupled to small side rack left side vertical support pole 140 by small side rack upper cross brace pole 142, small side rack middle cross brace pole 144, small side rack lower cross brace pole 146, small side rack lower U-pole bracket 148, small side rack middle U-pole bracket 150 and small side rack upper U-pole bracket 152. Small side rack upper cross brace pole 142 is mechanically coupled to small side rack left hook 154 and small side rack right hook 156.

A first small side rack frame assembly 134 is mechanically coupled to cargo rack 10 by placing small side rack left hook 154 and small side rack right hook 156 over left side upper cross brace pole 30 as shown in FIG. 2 and FIG. 3. A second small side rack frame assembly 134 is mechanically coupled to cargo rack 10 in a similar manner and is immediately adjacent to the first small side rack frame assembly 134.

FIG. 8 shows screw clamp 174. Screw clamp 174 comprises screw clamp screw 176 which is mechanically coupled to screw clamp base 178 at a first end and further comprises a screw clamp hook 180 that can be moved along screw clamp screw 176 by screw clamp knob 182.

Here, screw clamp 174 is shown mechanically coupling forward U-pole bracket 12 to UTV frame 168. A user first aligns forward U-pole bracket 12 to UTV frame 168 as shown in FIG. 2. Next a user links screw clamp 174 around a corner of UTV frame and then links screw clamp hook 180 around forward U-pole bracket 12. The user completes the couple by tightening screw clamp hook 180 by turning screw clamp knob 182. This configuration is exemplary and not exclusive. For example, plurality of clamps may be used on forward lower cross bar 54, rear lower cross bar 56 and elsewhere as necessary for support

That which is claimed:

1. A cargo rack for a utility terrain vehicle comprising
the cargo rack further comprising a plurality of hollow tubes mechanically coupled to a plurality of hollow U-shaped tubes
where the cargo rack can be mechanically coupled to the utility terrain vehicle by a plurality of bolts and a plurality of screw clamps
where a screw clamp further comprises a screw clamp base, a screw clamp hook and a screw clamp knob.

2. The cargo rack of claim 1 further comprising
a large side rack assembly mechanically coupled to a right side upper cross brace pole
where the large side rack assembly further comprises an upper cross brace pole mechanically coupled to a right side vertical support pole;
where the upper cross brace pole is further mechanically coupled to a left side vertical support pole, a left hook and a right hook;
where the right side vertical support pole is further mechanically coupled to the left side vertical support pole by a middle cross brace pole, a lower cross brace pole, a lower U-pole bracket, a middle U-pole bracket and an upper U-pole bracket;
where the lower U-pole bracket is further mechanically coupled to a large rack frame assembly diamond grate.

3. The cargo rack of claim 1 further comprising,
a tail-gate frame assembly mechanically coupled to a rear U-pole bracket,
where the tail-gate frame assembly further comprises an upper brace pole which is mechanically coupled to lower brace pole by a right vertical brace pole, a right secondary vertical brace pole, a right tertiary vertical brace pole, a right quaternary vertical brace pole, a left vertical brace pole, a left secondary vertical brace pole, a left tertiary vertical brace pole, a Oft quaternary vertical brace pole and a tire bracket plate.

4. The cargo rack of claim 1 further comprising
a hang-on table frame assembly mechanically coupled to the cargo rack by placing a hang-on table right hook and a hang-on table left hook on a left side inner support U-pole bracket;
where the hang-on table right hook and the hang-on table left hook are mechanically coupled to the hang-on table frame assembly
where the hang-on table frame assembly further comprises a hang-on table U-pole which is mechanically coupled to a hang-on table cross pole brace and a hang-on table assembly diamond grate.
